(19) United States
(12) Patent Application Publication
(10) Pub. No.: US 2001/0018293 A1
(43) Pub. Date: Aug. 30, 2001

(54) Connector for a cable and kit for assembling the same

(75) Inventor: Albertus Van Zanten, DP' s-Hertogenbosch (NL)

Correspondence Address: Clarence A. Green, PERMAN & GREEN, LLP, 425 Post Road, Fairfield, CT, 06430, US

(73) Assignee: Framatome Connectors International

(21) Appl. No.: 09/754,726

(22) Filed: Jan. 4, 2001

(30) Foreign Application Priority Data
Jan. 7, 2000 (NL) NL 1014037

(51) Int. Cl. H01R 9/03

(52) U.S. Cl. 439/610

(57) ABSTRACT

The invention pertains to a connector for a cable containing one or more conductors within a common shielding, which connector comprises a housing that comprises two or more constituent parts, a shielding and a passage for the cable and that accommodates at least one terminal block with terminals connected to the conductors in the cable. The shielding of the cable is placed over a rigid bush and is pressed against the bush by means a resilient ring washer that is placed over the shielding and that is compressed by the constituent parts of the housing.

The invention pertains to a connector for a cable containing one or more conductors within a common shielding, which connector comprises a housing that comprises two or more constituent parts, a shielding and a passage for the cable and that accommodates at least one terminal block with terminals connected to the conductors in the cable.

In the known connectors of this type, as for instance disclosed in U.S. Pat. No. 5,573,416, the connection of the common shielding of the cable to the shielding of the housing of the connector is rather critical in that forces exerted on the cable are transmitted virtually directly to this connection.

The invention aims to provide a connector of the above-mentioned type, wherein a secure connection between the shielding of the cable and the housing of the connector is established. Further, the said connector should be relatively small in size.

To this end, the invention is characterised in that the shielding of the cable is placed over a rigid bush and the shielding is pressed against the bush by means of a ring washer that is placed over the shielding and that is compressed by the constituent parts of the housing.

In a preferred embodiment, the ring washer comprises an opening, which renders it more resilient. It is further preferred that the ring washer is provided with a lip on both sides of the opening and that a first constituent part of the housing comprises a first stop and a second constituent part of the housing comprises a second stop and that the lips are urged together by the stops. In such embodiments, the lips will act as a spring that limits the forces that are exerted by the ring washer on the shielding of the cable and on the bush.

The bush preferably comprises a rim that has an outer diameter that is greater than the inner diameter of the passage for the cable. The said rim will prevent forces exerted on the cable from being transmitted to e.g. the terminal blocks or the terminals.

The invention further pertains to a kit for assembling a connector for a cable containing one or more conductors within a common shielding as described above, which at least comprises a housing that comprises two or more constituent parts and that is provided with a passage for a cable, a rigid bush, and a ring washer for clamping the shielding of the cable against the bush. The ring washer preferably comprises an opening. A lip can be provided on both sides of the opening.

The invention will be further explained by reference to the drawings in which an embodiment of the connector according to the present invention is schematically shown.

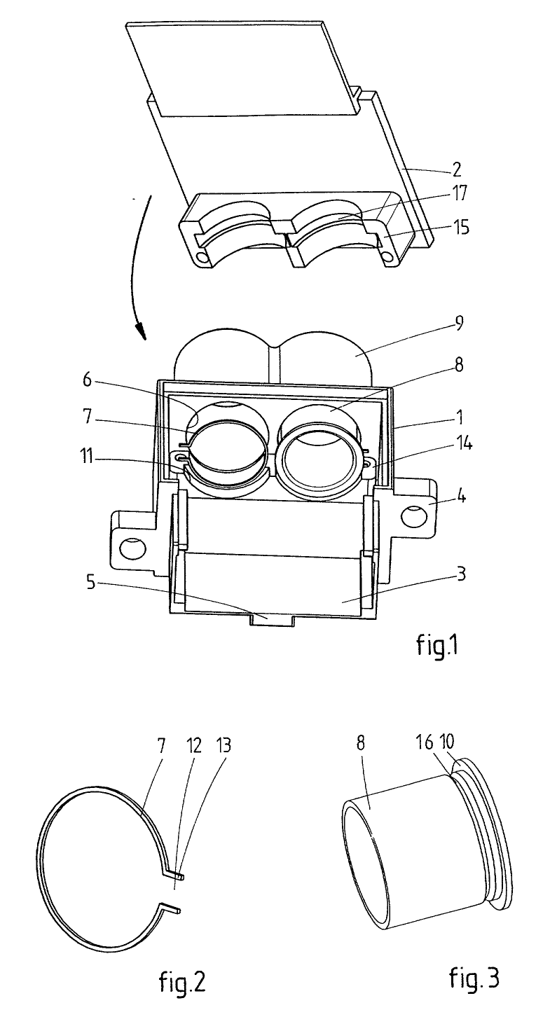

FIG. 1 is an exploded view of an embodiment of the connector according to the present invention.

FIG. 2 shows a ring washer for use in the connector according to FIG. 1.

FIG. 3 shows a bush for use in the connector according to FIG. 1.

FIG. 1 schematically shows a lower or main part 1 of the housing of a connector for a cable containing one or more conductors with a common shielding and an upper part or cover 2. The main part 1 and the cover 2 can be manufactured, e.g. by means of injection moulding a metal such as aluminium. It is also possible to use a thermoplastic material such as a liquid crystalline polymer (LCP) of nylon (for example PA66).

In that case, i.e. if the housing is made of an electrically insulating material, the main part 1 and cover 2 are preferably provided with a metal coating such that, upon completion of the housing, sufficient Electro Magnetic Interference or EMI shielding is obtained. To this end, the said part may be provided with an electrically conductive layer or coating (not shown). Such coatings are known to the person skilled in the art and may, for instance, comprise a copper layer with a thickness of say 1-2 μm on which a nickel of aluminium layer of say 2-3 μm has been deposited.

The main part 1 of the housing comprises a cavity 3 for accommodating one or more terminal blocks. The main part 1 further comprises means 4 for fastening the connector, such as holes for accommodating screws or the like, to e.g. the front panel of an electronic device such as a telephone exchange unit. The main part 1 further comprises a tongue 5 for aligning the connector with respect to the said electronic device. Two passages 6 are provided for letting through two cables (not shown), each at least comprising an outer jacket of an insulating material, conductors which are to be connected to the terminals in the terminal blocks, and a shielding for the conductors.

FIG. 1 further shows a ring washer 7 and a cylindrical ferrule or bush 8, which are shown in more detail in respectively FIG. 2 and FIG. 3 and which are positioned respectively near and in the said passages 6.

The bush 8 is provided with a groove 16 around its circumference, which groove 16 is positioned under the ring washer 7. Upon assembling the connector, the groove 16 will accommodate part of the shielding of the cable and, if the depth of the groove 16 is greater than the thickness of the shielding of the cable, part of the ring washer 7. Thus, the position of the said parts with respect to one another will be more secure.

The connector can be assembled as follows. A cable is passed through each of the passages 6 in the main part 1 of the housing. The cables are cut to size and the end part of the outer jacket is stripped off. Then, the end part of the shielding of the cable, which usually consists of a braid of electrically conductive wire such as copper wire, is removed. Then, a ring washer 7 is placed over the cable before placing a bush 8. The bush 8 is slid over the inner part of the cable, which inner part contains one or more conductors embedded in an electrically insulating material, and under the said braid.

Subsequently, the ring washer 7 is moved back over the braid. After stripping the conductors comprised in the cables, the conductors can be attached, e.g. by means of soldering, to their respective terminals, which are contained in the terminal blocks.

Upon completion of these connections, the terminal blocks are placed in the cavity 3 of the main part 1 of the housing and the cables are pulled back. The cylindrical part of the bushes 8 is positioned inside tubular section 9 of the main part 1 of the housing. This tubular section 9 ensures that the connection of the shielding of the cable to the bush 8 is primarily subjected to tensile and compresses forces and not to bending moments.

Each of the bushes 8 comprises a rim 10 which, when the cables are pulled back, falls into a groove or recess 11 which can be provided in the main part 1 of the housing adjacent the its respective passage 6. Tensile forces exerted on the cables are transmitted through the rim 10 to the groove or recess 11 and, thus, to the main part 1 of the housing.

As shown in FIGS. 1 and 2, the ring washers 7 comprise an opening 12 and are equipped with a lip 13 on either side of the opening 11. The main part 1 of the housing comprises a lower stop 14 to which the lower of the lips 13 abuts. Further, the cover 2 comprises an upper stop 15 that abuts the upper of the lips 13 of the ring washer 7.

Cover 2 can be provided with a groove 17 receiving a part of the rim 10. In fact, rim 10 can be received either in groove 11 of part 1 or groove 17 of part 2, or even simultaneously in grooves 11 and 17 of parts 1 and 2.

Upon closing of the housing, the lips 13 are clamped between upper stop 15 and lower stop 14 and pushed towards each other. Thus, the force exerted by the ring washer 7 on the braid is distributed evenly of the circumference of the latter. Also, if the force exerted on the lips 13 exceeds a certain maximum, for instance as a result of variations in the dimensions of the constituent parts 1, 2 of the housing and/or the dimensions of the stops 14, 15, the lips 13 will bend and overloading of the ring washer 7, the braid, the bush 8 and indeed the constituent parts 1, 2 of the housing is avoided.

The invention is not restricted to the above described embodiments which can be varied in a number of ways within the scope of the claims.

1. Connector for a cable containing one or more conductors within a common shielding, which connector comprises a housing that comprises two or more constituent parts, a shielding and a passage for the cable and that accommodates at least one terminal block with terminals connected to the conductors in the cable, characterised in that the shielding of the cable is placed over a rigid bush and that the shielding is pressed against the bush by means a resilient ring washer that is placed over the shielding and that is compressed by the constituent parts of the housing.

2. Connector according to claim 1, wherein the ring washer comprises an opening.

3. Connector according to claim 2, wherein a lip is provided on both sides of the opening and a first constituent part of the housing comprises a first stop and a second constituent part of the housing comprises a second stop and wherein the lips are urged together by the stops.

4. Connector according to any one of the preceding claims, wherein the bush is provided with a groove around its circumference, which groove is positioned under the ring washer.

5. Connector according to any one of the preceding claims, wherein the bush comprises a rim that has an outer diameter that is greater than the inner diameter of the passage for the cable.

6. Connector according to claim 5, wherein at least one of the constituent parts of the housing comprises a groove for accommodating the rim of the bush.

7. Connector according to any one of the preceding claims, wherein the shielding of the cable comprises or consists of an electrically conductive braid.

8. Kit for assembling a connector for a cable containing one or more conductors within a common shielding according to any one of the preceding claims, at least comprising a housing that comprises two or more constituent parts and that is provided with a passage for a cable, a rigid bush, and a ring washer for clamping the shielding of the cable against the bush.

9. Kit according to claim 8, wherein the ring washer comprises an opening.

10. Kit according to claim 9, wherein a lip provided on both sides of the opening.
